(19) United States
(12) Patent Application Publication
(10) Pub. No.: US 2026/0022884 A1
(43) Pub. Date: Jan. 22, 2026

(54) REFRIGERATOR

(71) Applicant: LG Electronics Inc., Seoul (KR)

(72) Inventor: Kwanghyun CHOI, Seoul (KR)

(21) Appl. No.: 19/273,554

(22) Filed: Jul. 18, 2025

(30) Foreign Application Priority Data
Jul. 19, 2024 (KR) 10-2024-0095457

(51) Int. Cl. F25D 23/02; E05D 11/00; E05D 11/06

(52) U.S. Cl. CPC F25D 23/028; E05D 11/0054; E05D 11/06; E05Y 2900/31; F25D 2323/024; F25D 2400/18

(57) ABSTRACT

A refrigerator includes a cabinet, a door, and a hinge including a hinge extension part that is fixed to the cabinet and extends forward, and a shaft that extends upward from the hinge extension part and is inserted into a lower portion of the door. The door includes a door panel, a cap decoration defining a lower surface of the door, a stopper fixed to the lower surface, protruding downward in front of the shaft of the hinge, and contacting the hinge extension part when the door opens to a maximum opening angle, to limit rotation of the door, and a cover vertically passing through the cap decoration at a position behind the front surface of the lower portion of the door and protruding downward from the lower surface, the cover being disposed in front of the stopper to at least partially cover the stopper from a front side.

### BACKGROUND

### 1. Field of the Invention

The following disclosure relates to a refrigerator, and more particularly to a refrigerator door.

### 2. Description of the Related Art

A refrigerator is an appliance to keep food stored in a storage compartment at low temperatures by supplying cold air to the storage compartment. The refrigerator can supply cold air by performing heat exchange between air and refrigerant circulating in a refrigerating cycle.

In order to meet the demand for larger storage space, an additional storage space is provided by using shelves in the door of a refrigerator and the like in addition to a storage space inside a cabinet. As the additional storage space increases, the thickness of an existing refrigerator door increases more than it requires to open and close a storage space in a cabinet.

In recent living environments, a cabinet to accommodate a refrigerator is provided or a refrigerator is placed next to other furniture.

The existing refrigerator with a thick door has a problem in that its thickness in the front-rear direction is larger than the thickness of a refrigerator cabinet or other furniture, such that the refrigerator protrudes more forwardly than other furniture, causing inconvenience to users, and adversely affecting the interior design.

In consideration of the above problem, there is a growing demand for a refrigerator including a door with reduced thickness.

Meanwhile, in consideration of the damage, load, and the like of the refrigerator door, a stopper is provided to limit an opening angle.

Korean Laid-open Patent Publication No. 10-2023-0082479 discloses a stopper.

The stopper comes into contact with another component, such as hinge and the like made of metal, to limit an opening angle of a refrigerator, and the stopper may also be made of metal in consideration of durability.

There may be safety concerns when the stopper made of a metal material is disposed close to the front end of a door and is exposed forward.

### SUMMARY

It is an objective of the present disclosure to solve the above and other problems.

It is another objective of the present disclosure to provide a refrigerator including a cover that prevents exposure of a stopper.

It is yet another objective of the present disclosure to provide a refrigerator including a door with reduced thickness.

It is yet another objective of the present disclosure to provide a refrigerator including a cover that is not easily exposed to a user.

It is yet another objective of the present disclosure to provide a refrigerator including the cover that is not easily exposed to a user while having reduced thickness.

It is yet another objective of the present disclosure to provide a refrigerator capable of being easily manufactured while having a step formed between the cover and a front surface of a cap decoration that defines a lower portion of a door.

It is yet another objective of the present disclosure to provide a refrigerator capable of facilitating assembly of a cover and a cap decoration.

It is yet another objective of the present disclosure to provide a refrigerator capable of facilitating installation of a cover, a stopper, and a bushing that are coupled to a cap decoration.

It is yet another objective of the present disclosure to provide a refrigerator capable of preventing a door from protruding outward in a width direction of the refrigerator when the door opens.

The objectives of the present disclosure are not limited to the aforementioned objectives and other objectives not described herein will be clearly understood by those skilled in the art from the following description.

In accordance with an aspect of the present disclosure, the above and other objectives can be accomplished by providing a refrigerator including: a cabinet defining a storage compartment; a door configured to open and close the storage compartment; and a hinge including a shaft that is inserted into a lower portion of the door.

The storage compartment may be opened forward.

The door may be rotatably disposed at a front of the cabinet. The position of a rotation axis of the door may be fixed. Alternatively, the position of the rotation axis may vary according to an opening degree of the door.

The hinge may include a hinge extension part that is fixed to the cabinet. The hinge extension part may extend forward.

The shaft of the hinge may extend upward from the hinge extension part. One hinge shaft may be provided for one hinge extension part. For example, the hinge disposed at the bottom of one door may be provided with a center of rotation by one hinge shaft.

Alternatively, two or more hinge shafts may be provided for one hinge extension part. For example, the hinge disposed at the bottom of one door may be provided with a center of rotation by two hinge shafts. In this case, the position of a rotation axis of the door may vary according to an opening degree of the door.

The door may include a door panel and a cap decoration.

The door panel may define a front surface of the door.

The door panel may define a lateral surface of the door.

The door panel may include a lower end bent portion that is bent rearward from the front surface of the door panel.

The cap decoration may define a lower surface of the door. The cap decoration may be coupled to the door panel.

The cap decoration may include: a bottom defining the lower surface of the door; and a front surface facing forward and extending upward from the bottom to be connected to the door panel.

A rear surface of the front surface of the cap decoration may extend vertically from an upper end. Alternatively, a rear surface of the front surface of the cap decoration may extend obliquely and downwardly from the upper end.

The door may further include a stopper.

The stopper may limit rotation of the door when the door opens to a predetermined maximum opening angle.

The stopper may protrude downward from the door. The stopper may protrude downward in front of the shaft of the hinge.

The stopper may include a stopper body protruding downward. The stopper body may be disposed in front of the shaft of the hinge. The stopper body may come into contact with the hinge extension part when the door opens to the maximum opening angle.

The hinge extension part may include a contact portion that comes into contact with the stopper body. The contact portion may be inclined so that an inner end thereof is disposed at a front side and an outer end thereof is disposed at a rear side.

The stopper may be fixed to the lower surface of the door.

The stopper may include a stopper base coupled to a lower side of the bottom of the cap decoration.

The stopper body may extend downward from the stopper base.

The refrigerator (or the door) may further include a bushing configured to accommodate the shaft of the hinge.

The stopper base may include a bushing insertion hole. The bushing may be inserted into the bushing insertion hole.

The bushing may have a rim extending outward from a lower end. The rim may extend along a circumference of a lower end of the bushing.

The rim may support the stopper base from below the stopper base.

The bushing may include a hook that protrudes upward.

The cap decoration may further include a bushing mount recessed upward from the bottom of the cap decoration to accommodate the bushing

The bushing mount may have a hole into which the hook is inserted. The hook is inserted into the hole and caught by the bushing mount to allow the bushing to be coupled to the bushing mount.

A groove of the bushing may include: a first curved part at which the shaft of the hinge is located when the door is in a closed state, the first curved part extending convexly rearward; and a second curved part at which the shaft of the hinge is located when the door opens to the maximum opening angle, the second curved part extending from the first curved part and having a smaller radius of curvature than the first curved part.

The refrigerator may further include a cover disposed in front of the stopper. The cover may cover the stopper from a front side. The cover may cover at least partially the stopper from the front side.

The cover may be disposed behind the front surface of the lower portion of the door. The cover may be disposed behind the front surface of the cap decoration. The cover may include a cover body disposed behind the front surface of the cap decoration.

The cover may protrude downward from the lower surface of the door. The cover may vertically pass through the cap decoration to protrude downward from the lower surface of the door.

The cover may include a cover part protruding downward from the lower surface of the door. The cover part may extend downward from the cover body. The cover part may pass through the cap decoration.

The cover part may cover at least partially the stopper from the front side. One end of the stopper body may be disposed more outwardly than one end of the cover in the width direction of the door to be exposed forward.

The cover may include an upper end disposed at a rear of the door panel.

The cover may include a cover extension part extending rearward and downward from the upper end so that a first coupling groove, in which the lower end bent portion of the door panel is accommodated, is formed between the front surface of the cap decoration and the upper end of the cover.

The cover body may extend downward from the cover extension part.

The cover may further include a rib protruding from the cover extension part toward the door panel, the rib spaced upward from the front surface of the cap decoration.

The lower end bent portion of the door panel may be inserted between the rib and the front surface of the cap decoration.

The cap decoration may include a first part and a second part that are arranged in a width direction of the door.

The hinge, the stopper, and the cover may be disposed at the first part

The front surface of the cap decoration may define an upper end of the first part, and the upper end of the cover and the cover extension part may be disposed at an upper side of the upper end of the first part.

The second part may include: a first decoration extension part that is disposed parallel to the upper end of the cover; a second decoration extension part that is disposed parallel to the cover extension part and defines a second coupling groove extending from the first coupling groove; and a third decoration extension part extending rearward from a lower end of the second decoration extension part.

A front surface of the second part may be connected to a rear end of the third decoration extension part and may be disposed behind a front surface of the first part.

The cap decoration may include a slit extending from the bottom along the front surface in the width direction of the door. The slit may be disposed at a rear of the front surface.

The slit may be spaced rearward from the front surface of the cap decoration, and the front surface of the cover part may be disposed behind the front surface of the cover body such that a step is formed between the front surface of the cover body and the front surface of the cover part, wherein the step may be supported by the bottom of the cap decoration.

The cap decoration may include a support wall protruding upward from a rear side of the slit, wherein the cover body may be inserted between the front surface of the cap decoration and the support wall.

The support wall may include a first support wall and a second support wall that are spaced apart from each other in the width direction of the door, wherein the cover further includes a fastening portion protruding rearward from the cover body and inserted between the first support wall and the second support wall.

The refrigerator may further include a first fastening member passing through the cap decoration from below the cap decoration, and coupled to the fastening portion.

The fastening portion may be disposed between the bushing and the automatic closing device.

The fastening member may pass through the stopper base and the bottom of the cap decoration to be fastened to the fastening portion.

A distance between the cover and the front surface of the door in a front-rear direction when the door closes the storage compartment may be shorter than a distance between the shaft of the hinge and the cover in the front-rear direction.

According to an embodiment of the present disclosure, a refrigerator includes: a cabinet defining a storage compartment that is opened forward; a door rotatably disposed at a front of the cabinet and configured to open and close the storage compartment; and a hinge including a hinge extension part that is fixed to the cabinet and extends forward, and a shaft that extends upward from the hinge extension part and is inserted into a lower portion of the door.

The door includes: a door panel defining a front surface of the door; a cap decoration coupled to the door panel and defining a lower surface of the door; a stopper fixed to the lower surface of the door, protruding downward in front of the shaft of the hinge, and contacting the hinge extension part when the door opens to a predetermined maximum opening angle, to limit rotation of the door; and a cover vertically passing through the cap decoration at a position behind the front surface of the lower portion of the door and protruding downward from the lower surface of the door, the cover disposed in front of the stopper to at least partially cover the stopper from a front side.

According to an embodiment of the present disclosure, a refrigerator includes: a cabinet defining a storage compartment that is opened forward; a door rotatably disposed at a front of the cabinet and configured to open and close the storage compartment; and a hinge including a shaft that is fixed to the cabinet and is disposed vertically to be inserted into a lower portion of the door.

The door further includes: a door panel including a front surface and a lower end bent portion that is bent rearward from a lower end of the front surface; a cap decoration coupled to the door panel and defining a lower surface of the door; a stopper fixed to the lower surface of the door and protruding downward in front of the shaft of the hinge; and a cover coupled to the cap decoration.

The cover includes: an upper end disposed at a rear of the door panel and an upper side of the front surface of the cap decoration; a cover extension part extending rearward and downward from the upper end so that a first coupling groove, in which the lower end bent portion of the door panel is accommodated, is formed between the front surface of the cap decoration and the upper end of the cover; a cover body extending downward from the cover extension part, and disposed at the rear of the front surface of the cap decoration; and a cover part vertically passing through the cap decoration to protrude downward from the lower surface of the door, and disposed in front of the stopper to at least partially cover the stopper from a front side.

According to an embodiment of the present disclosure, a refrigerator includes: a cabinet defining a storage compartment that is opened forward; a door rotatably disposed at a front of the cabinet and configured to open and close the storage compartment; and a hinge including a hinge extension part that is fixed to the cabinet and extends forward, and a shaft that extends upward from the hinge extension part and is inserted into a lower portion of the door.

The door includes: a stopper fixed to the lower surface of the door, protruding downward in front of the shaft of the hinge, and contacting the hinge extension part when the door opens to a predetermined maximum opening angle, to limit rotation of the door; and a cover provided on the lower surface of the door, protruding downward behind a front surface of the door, and disposed in front of the stopper to at least partially cover the stopper from a front side, wherein a distance between the cover and the front surface of the door in a front-rear direction when the door closes the storage compartment is shorter than a distance between the shaft of the hinge and the cover in the front-rear direction.

Other detailed matters of the exemplary embodiments are included in the detailed description and the drawings.

According to at least one of the embodiments of the present disclosure, a refrigerator including a cover that prevents exposure of a stopper may be provided.

According to at least one of the embodiments of the present disclosure, a refrigerator including a door with reduced thickness may be provided.

According to at least one of the embodiments of the present disclosure, a refrigerator including a cover that is not easily exposed to a user may be provided.

According to at least one of the embodiments of the present disclosure, there may be provided a refrigerator including the cover that is not easily exposed to a user while having reduced thickness.

According to at least one of the embodiments of the present disclosure, there may be provided a refrigerator capable of being easily manufactured while having a step formed between the cover and a front surface of a cap decoration that defines a lower portion of a door.

According to at least one of the embodiments of the present disclosure, there may be provided a refrigerator capable of facilitating assembly of a cover and a cap decoration.

According to at least one of the embodiments of the present disclosure, there may be provided a refrigerator capable of facilitating installation of a cover, a stopper, and a bushing that are coupled to a cap decoration.

According to at least one of the embodiments of the present disclosure, there may be provided a refrigerator capable of preventing a door from protruding outward in a width direction of the refrigerator when the door opens.

### BRIEF DESCRIPTION OF THE DRAWINGS

FIG. 1 is a front view illustrating a refrigerator according to an embodiment of the present disclosure.

FIG. 2 is a perspective view illustrating a lower surface of a door of an existing refrigerator.

FIGS. 3 and 4A and 4B are diagrams illustrating a refrigerator according to various embodiments of the present disclosure.

FIGS. 5A and 5B are schematic views illustrating a cross section of a lower portion of a refrigerator according to an embodiment of the present disclosure.

FIG. 6 is an enlarged view illustrating a lower portion of a door of the refrigerator illustrated in FIG. 1.

FIG. 7 is a perspective view illustrating a lower portion of the door illustrated in FIG. 6.

FIG. 8 is a bottom view illustrating a refrigerator in a closed state and in a state where it is opened to a predetermined angle.

FIGS. 9A and 9B are bottom views of the door illustrated in FIG. 7.

FIG. 10 is an exploded perspective view illustrating a lower portion of a door of a refrigerator according to an embodiment of the present disclosure.

FIGS. 11A and 11B are perspective views illustrating coupling of a cap decoration and a cover of a refrigerator according to an embodiment of the present disclosure.

FIGS. 12 to 14 are cross-sectional views of the refrigerator illustrated in FIG. 11.

FIG. 15 is a plan view illustrating a cap decoration of a refrigerator according to an embodiment of the present disclosure.

FIGS. 16A to 16F are perspective views illustrating coupling of a cap decoration of a refrigerator and components coupled thereto, according to an embodiment of the present disclosure.

FIG. 17 is a cross-sectional view of a lower portion of a refrigerator according to another embodiment of the present disclosure.

### DETAILED DESCRIPTION

Hereinafter, the present disclosure will be described in detail with reference to the accompanying drawings, in which the same reference numerals are used throughout the drawings to designate the same or similar components, and a redundant description thereof will be omitted.

The suffixes, such as “module” and “unit,” for elements used in the following description are given simply in view of the ease of the description, and do not have a distinguishing meaning or role.

In addition, it will be noted that a detailed description of known arts will be omitted if it is determined that the detailed description of the known arts can obscure the embodiments of the present disclosure. Further, the accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that, although the terms first, second, etc., may be used herein to describe various elements, these elements should not be limited by these terms. These terms are only used to distinguish one element from another.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

A singular representation may include a plural representation unless context clearly indicates otherwise.

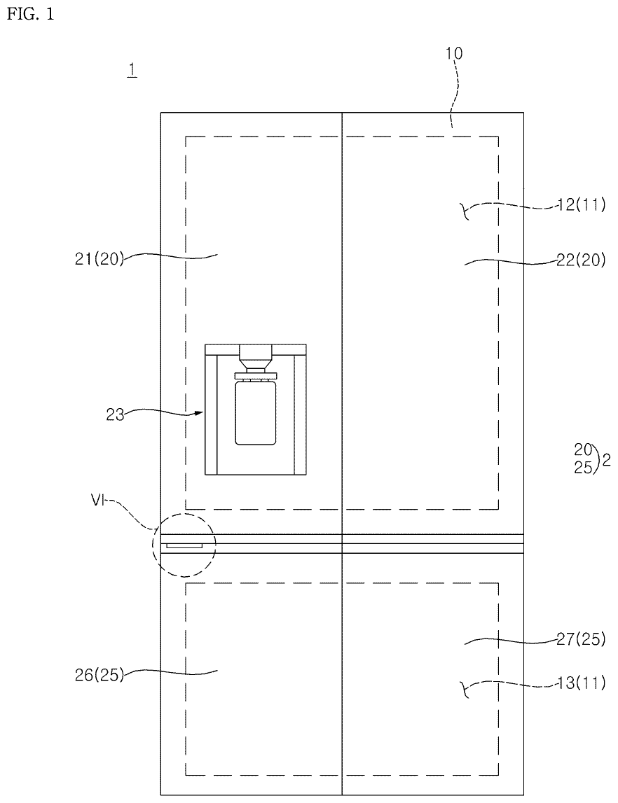

Referring to FIG. 1, a refrigerator 1 according to an embodiment of the present disclosure includes a cabinet 10 defining a storage compartment 11, and a door 2 configured to open and close the storage compartment 11.

The storage compartment 11 may be opened forward. The door 2 may be disposed at the front of the cabinet 10 to open and close the storage compartment 11. The door 2 may be rotatably disposed at the front of the cabinet 10 to open and close the storage compartment 11.

A plurality of storage compartments 11 may be provided. For example, the storage compartment 11 may include an upper storage compartment 12 and a lower storage compartment 13 that are vertically partitioned. The upper storage compartment 12 may be provided as a refrigerating compartment, and the lower storage compartment 13 may be provided as a freezing compartment. However, the configuration of the refrigerating compartment and the freezing compartment is not limited thereto.

The door 2 may include an upper door 20 configured to open and close the upper storage compartment 12. The door 2 may include a lower door 25 configured to open and close the lower storage compartment 13.

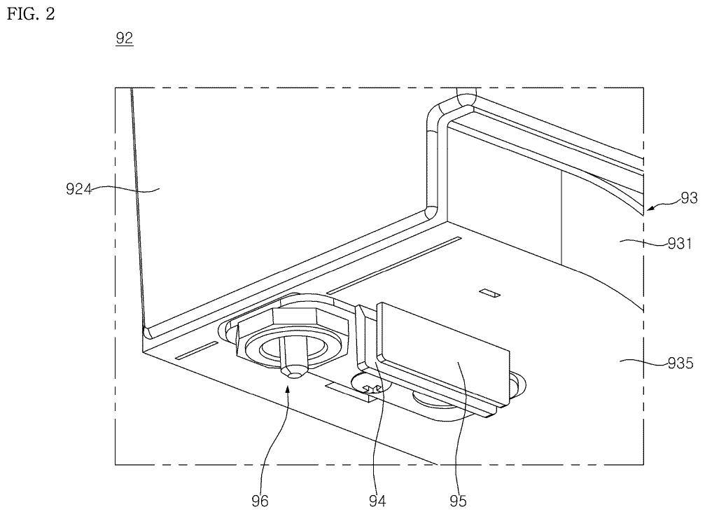

A plurality of doors 2 may be provided. The plurality of doors 2 may open and close one storage compartment. For example, both of a first door 21 and a second door 22 may open and close one upper storage compartment 12. That is, the first door 21 may open and close a portion (left side in FIG. 1) of the upper storage compartment 12, and the second door 22 may open and close another portion (right side in FIG. 2) of the upper storage compartment 12.

Unlike the example, a plurality of doors 20 may be provided, and one door may open and close one storage compartment. For example, the lower storage compartment 13 may be horizontally divided into two storage compartments, and a lower door 25 configured to open and close the lower storage compartment 12 may include a first lower door 26 configured to open and close a left lower storage compartment and a second lower door 27 configured to open and close a right lower storage compartment.

The storage compartment 11 and the door 20 provided in plurality as described above may be configured differently. For example, the upper storage compartment 12 may be horizontally divided, or the lower storage compartment 13 may not be horizontally divided but may be provided as one storage compartment.

Food may be stored in the storage compartment 11. Cold air may be supplied to the storage compartment 11. The door 20 may close the storage compartment 11 to prevent the cold air from leaking to the outside.

The refrigerator 1 may include a refrigerating cycle. The refrigerator 1 may supply cold air to the storage compartment by performing heat exchange between air and refrigerant in the refrigerating cycle.

The door 20 may be opened to allow a user to access the storage compartment 11.

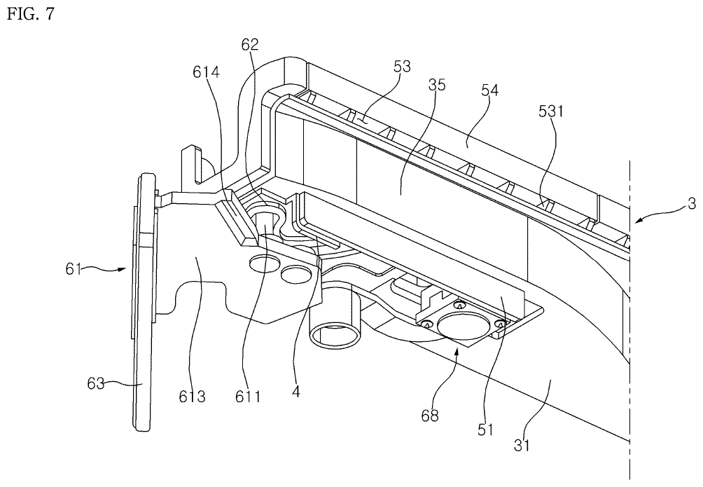

The door 20 may be rotatably disposed at the front of the cabinet 10 to open and close the storage compartment 11. The refrigerator 1 may further include a hinge 61 (see FIG. 7) rotatably supporting the door 20.

The hinge 61 will be described in detail with reference to FIGS. 7 to 9.

The door 20 may include a dispenser 23. The dispenser 23 may be connected to a water tank inside the refrigerator or an external water source provided outside the refrigerator to supply water.

The dispenser 23 may be mounted in any one door 21 among a plurality of doors. For example, the dispenser 23 may be provided in the first door 21.

A shelf and/or a drawer may be disposed inside the storage compartment 11.

The door 2 may also be provided with a shelf to store food.

In order to increase the storage capacity of the door, the existing refrigerator includes a thick door (see FIG. 2).

Hereinafter, an existing door 92 will be described with reference to FIG. 2.

Referring to FIG. 2, the door 92 includes a door panel 924 defining a front surface and a lateral surface of the door 92, and a cap decoration 93 defining a bottom surface 935 of the door.

The cap decoration 93 defines the bottom surface 935 of the door 92 and a front surface 931 of the bottom of the door 92. The bottom surface 935 may also be referred to as a bottom 935 of the cap decoration 93. The front surface 931 of the bottom may also be referred to as a front 931 of the cap decoration 93.

A hinge 96 may be fixed to the cabinet 10 (see FIG. 1) and may extend forward. A shaft of the hinge 96 may vertically extend to provide a rotation axis of the door 92. The door 92 may be provided to be rotatable about the shaft of the hinge 96.

The door 92 may include a stopper 94. The stopper 94 may prevent excessive rotation of the door. When the door 92 rotates from a closed position by a predetermined angle, the stopper 94 may come into contact with the hinge 96 or another component to limit rotation of the door 92.

The stopper 94 may be disposed in front of the hinge 96 in a front-rear direction.

The hinge 96 supports the door 92. Accordingly, it is desirable that the shaft of the hinge 96 is located at a position spaced apart from a rear end of the door 92, rather than located at the rear end.

The door 92 includes a cover 95 disposed in front of the stopper 94. The cover 95 may prevent the stopper 94 from being exposed forward.

The cover 95 may be formed as one body with the cap decoration 93. The cover 95 may protrude downward from the bottom 935 of the cap decoration 93.

The existing door 92 is thick such that the cover 95 may be disposed behind the front surface 931 of the cap decoration 93.

The hinge disposed at the bottom of the upper door is generally located below a user's eye level, such that the cover 95 disposed behind the front surface of the cap decoration 93 may not be visible to the user.

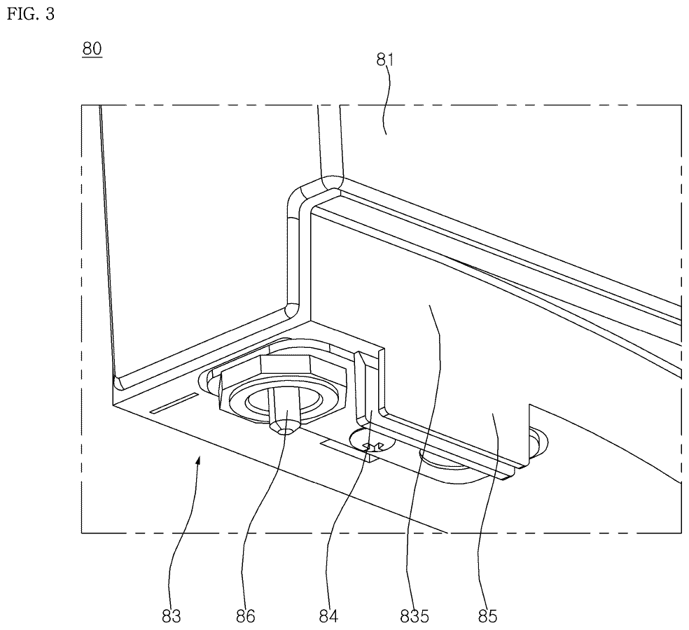

Recently, there is a growing demand for a refrigerator having a door 80 with reduced thickness as illustrated in FIG. 3, compared to the existing door.

Hereinafter, refrigerators according to various embodiments of the present disclosure will be described with reference to FIGS. 3 to 5. Descriptions of features that are the same as or similar to those in other embodiments and can be understood without explanation will be omitted.

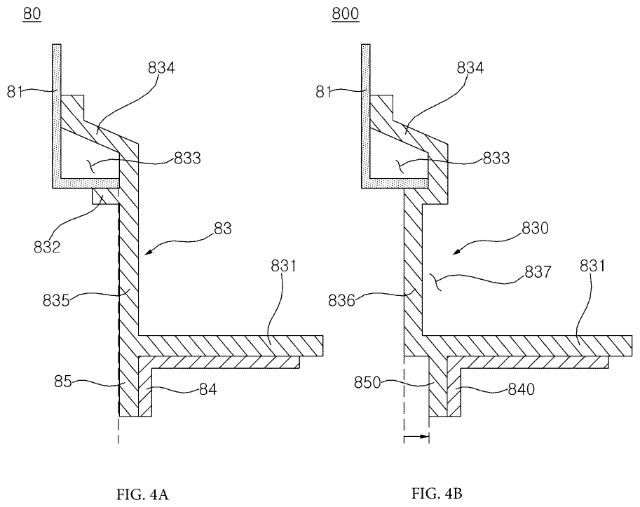

Referring to FIGS. 3 and 4(a), in consideration of the door 80 that stores food and insulates the inside of the storage compartment from the outside, and the position of the hinge 86, etc., the thickness of the door 80 may be reduced by a size of a portion corresponding to the front of the cover 95 of the door 92 of the existing refrigerator illustrated in FIG. 2.

The door 80 may include a door panel 81 and a cap decoration 83. A lower end of the door panel 81 may be bent rearward and may be coupled to the cap decoration 83.

The cap decoration 83 may include a coupling portion 834 and a protrusion 832. The coupling portion 934 may define an upper end of the cap decoration 83.

A coupling groove 833 may be formed between the coupling portion 834 and the protrusion 832, and the lower end of the door panel 81 is inserted into the coupling groove 833 such that the door panel and the cap decoration may be coupled to each other.

A stopper 84 is provided at the bottom 831 of the cap decoration 83, and the cover 85 is disposed at the front of the cap decoration 83. The cover 85 may be formed as one body with the cap decoration 83.

In the embodiment of FIGS. 3 and 4(a), the cover 85 may be disposed on the same plane as the front surface 835 of the cap decoration.

Accordingly, the cover 85 may be easily exposed to a user, which may cause a safety problem.

In order to address the above concern, a refrigerator in the embodiment of FIG. 4B includes a door 800 with a cover 850 disposed behind the front surface 836 of the cap decoration 830.

The cover 850 is disposed in front of the stopper 94 in order to prevent the stopper 94 from being exposed forward. The cover 850 may be formed as one body with the cap decoration 830.

In addition, as described above, the stopper 840 may be disposed in front of the hinge in the front-rear direction, and a shaft of the hinge may be located at a position spaced apart from the rear end of the door 800, compared to the case where the hinge shaft is located at the rear end of the door 800.

That is, it is not easy to change a position of the cover 850 to the rear side, compared to the position of the cover 850 illustrated in FIG. 4A.

Accordingly, the front surface 836 of the cap decoration 83 is moved forward in the embodiment of FIG. 4B, compared to the embodiment of FIG. 4A.

The protrusion 832 in FIG. 4A defines the upper end of the front surface 836, and the coupling groove 833 is formed between the upper end of the front surface and the coupling portion 834, and the lower end of the door panel 81 is inserted into the coupling groove.

A rear side of the coupling portion 834 is located behind the front surface 836, and a space 837 is formed between a lower side of the coupling portion 834 and a rear side of the front surface 836. It is not easy to remove a mold when the cap decoration 830 having an undercut 837 formed at the bottom of the coupling portion 834 is injection-molded.

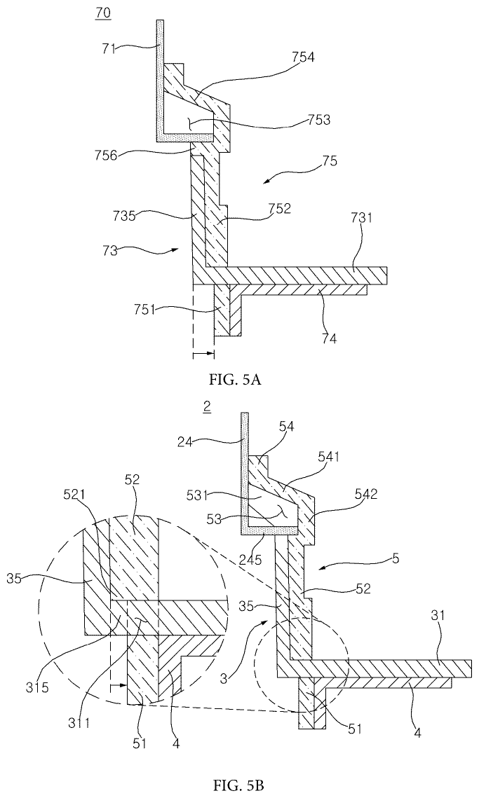

The problem of the embodiment of FIG. 4B can be solved according to embodiments of FIGS. 5A and 5B.

Referring to FIG. 5A, a door 70 may include a cover 75 and a cap decoration 73 that are manufactured separately. The cover 75 may be coupled to the cap decoration 73.

The cap decoration 73 may include a front surface 735 and a bottom 731.

The cover 75 may pass through the cap decoration 73. The cover 75 may include a body 752 disposed at the rear of the front surface 735 of the cap decoration 73, and a cover part 751 extending downward from the body 752 to pass through the bottom 731 of the cap decoration 83 and disposed in front of the stopper 74. The cover part 751 may be disposed behind the front surface 735 of the cap decoration 73.

The cover 85 may include a protrusion 756 protruding forward from an upper end of the body 752. The protrusion 756 may be disposed at an upper side of the front surface 735.

The cover 75 may include a coupling portion 754 coupled to the door panel 71. The coupling portion 754 may be disposed at the rear of the door panel 71.

A coupling groove 753 may be formed between the coupling portion 754 and the protrusion 756. The lower end of the door panel 71 may be inserted into the coupling groove 753 such that the door panel 71 may be coupled to the cover 75.

A rear surface of the front surface 735 of the cap decoration 73 may extend vertically from the upper end or may be inclined or stepped so that the lower end may be located at the rear thereof.

In the embodiment of FIG. 5A, an undercut is not formed in the cap decoration 73, such that the cap decoration 75 may be easily manufactured, and the cover part 751 may be located behind the front surface 735 of the cap decoration 73.

In a refrigerator according to the embodiment of FIG. 5B, a coupling structure of a door panel 24, a cap decoration 3, and a cover 5 is different from the refrigerator according to the embodiment of FIG. 5A.

The door 2 may include the door panel 24 and the cap decoration 3.

The door panel 24 may define the front surface of the door 2. The door panel 24 may include a lower end bent portion 245 that is bent rearward from a lower end of the front surface. The lower end bent portion 245 may be inserted into a coupling groove 53 which will be described later.

The cap decoration 3 may define a lower surface 31 of the door 2. The lower surface 31 of the door 2 may be referred to as the bottom of the cap decoration 3.

The cap decoration 3 may include a front surface 35. The front surface 35 of the cap decoration 3 may define the front surface of a lower side of the door 2. The front surface 35 of the cap decoration 3 may be disposed behind the front surface of the door panel 24 (or the front surface of the door).

A rear surface of the front surface 35 of the cap decoration 3 may extend vertically from the upper end or may be inclined or stepped so that the lower end may be located at the rear thereof.

The door 2 may include a stopper 4. The stopper 4 may be coupled to the lower surface 31 of the door 2. The stopper 4 may be fixed to the lower surface 31 of the door 2.

The stopper 4 may protrude downward. The stopper 4 may be disposed in front of a shaft 611 of a hinge 61 (see FIGS. 7 to 9).

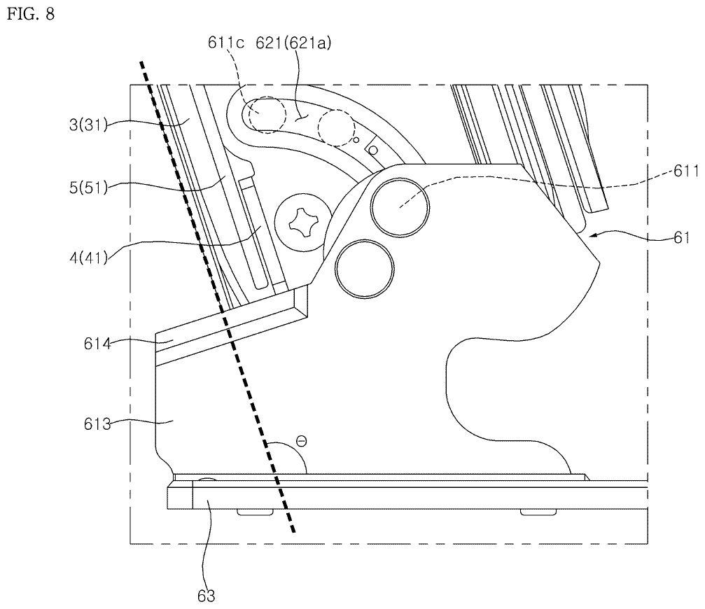

When the door 2 opens to the maximum opening angle (θ, see FIG. 8), the stopper 4 may come into contact with the hinge 61. Accordingly, the stopper 4 may limit rotation of the door. The maximum opening angle θ may refer to an angle at which the stopper body comes into contact with the hinge 61 (a contact portion 614 of the hinge extension part 613) to limit further rotation of the door 2. For example, the maximum opening angle may be larger than 90 degrees. The maximum opening angle θ may be about 90 degrees to 120 degrees, depending on the door size and design.

The door 2 may include the cover 5. The cover 5 may include a cover part 51 disposed in front of the stopper 4. The cover part 51 may be disposed behind the front surface 35 of the cap decoration 3.

Accordingly, it is possible to minimize exposure of the stopper 4 and the cover 5 to the front side.

The cover 5 may include a cover body 52 disposed at the rear of the front surface 35 of the cap decoration 53.

Unlike the cover body 752 in the embodiment of FIG. 5A, the cover body 52 in the embodiment of FIG. 5B may not be caught by the upper end of the front surface of the cap decoration 35.

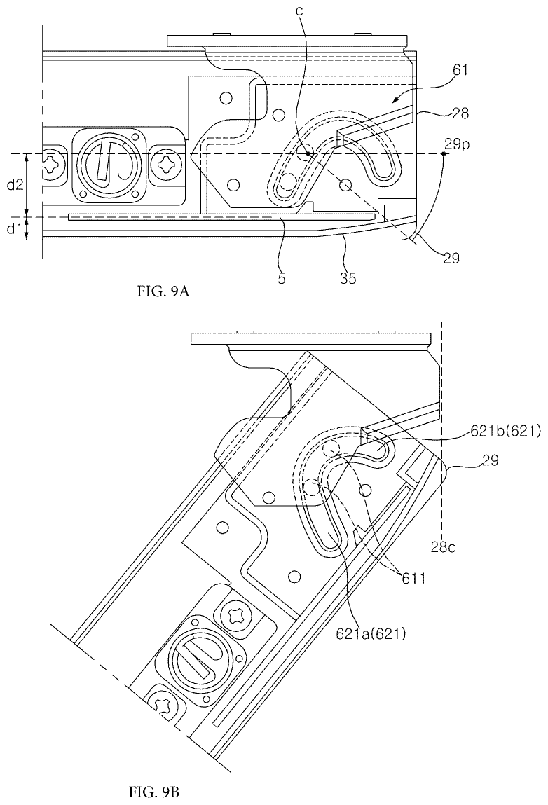

The thickness of the cover body 52 in the front-rear direction may be greater than the thickness of the cover part 51. In addition, the length of the cover body 52 in the left-right direction may be greater than the length of the cover part 510 (see FIGS. 9A and 9B).

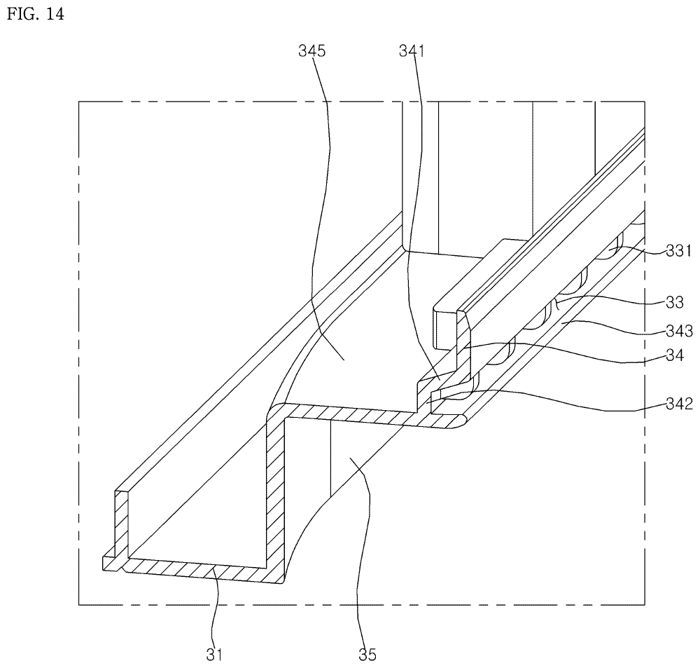

The cover 5 may pass through the bottom 31 of the cap decoration 3. A slit 311, into which the cover part 51 is inserted, may be formed in the bottom 31 of the cap decoration 3. The size of the slit 311 in the front-rear direction may be smaller than the thickness of the cover body 52 in the front-rear direction. The length of the slit 311 in the left-right direction (see FIG. 14) may be smaller than the length of the cover body 52 in the left-right direction.

The slit 311 may be spaced rearward from the front surface 35. A front end 315 of the bottom 31 that is connected to the front surface 35 may be disposed in front of the slit 315.

The cover 5 may have a step 521 formed due to a difference in thickness between the cover body 52 and the cover part 51. The front surface of the cover part 51 may be disposed behind the front surface of the cover body 52, and the step 521 may connect a front bottom of the cover body 52 and a front top of the cover part 51.

As the step 521 of the cover 5 is formed at the front end 315 of the bottom 31 of the cap decoration 3, the depth at which the cover 5 is inserted may be determined.

The cover 5 includes a coupling portion 54, 541, and 542. The coupling portion 54, 541, and 542 may define the coupling groove 53, and the lower end bent portion 245 may be inserted into the coupling groove 53. The coupling groove 53 may be referred to as a first coupling groove 53.

The cover 5 may include an upper end 54. The upper end 54 may be disposed at the rear of the door panel 24.

The cover 5 may include an extension part 541 and 542 extending between the upper end 54 and the cover body 52. The extension part 541 may include a first extension part 541 extending rearward from the upper end 54, and a second extension part 542 extending downward from the first extension part 541. The second extension part 542 may be connected to the cover body 52.

A rib 531 may be formed on the coupling groove 53. The rib 531 may be spaced upward from the upper end of the cap decoration 35 and the upper end of the cover body 52. The lower end bent portion 245 may be inserted into a gap between the upper end of the rib 531 and the cap decoration 35 and the upper end of the cover body 52.

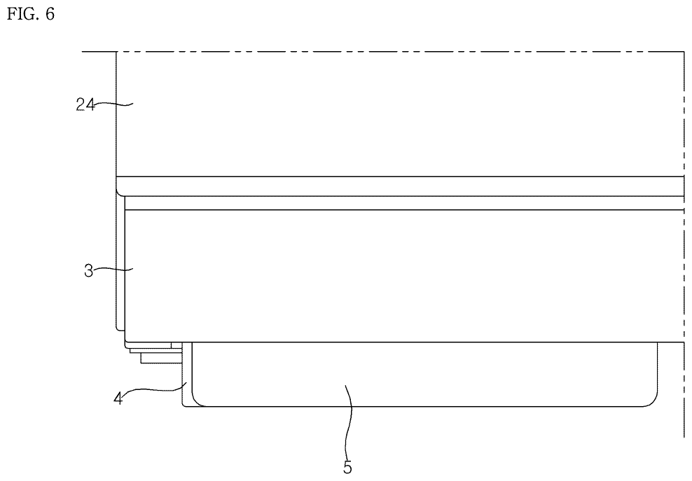

FIG. 6 is an enlarged view illustrating a lower portion VI of the door 2 illustrated in FIG. 1.

Referring to FIG. 6, the door 2 may include a door panel 24 defining a front surface of the door 2, and a cap decoration 3 coupled to the door panel 24 and defining a lower portion of the door.

The front surface 35 of the cap decoration 3 may be disposed below the door panel 24 and may be disposed behind the front surface of the door panel 24 (see FIGS. 5A and 5B).

The door 2 may include a stopper 4 protruding downward from the lower surface 31, and the cover 5 protruding downward from the lower surface 31 and placed in front of the stopper 4 to at least partially cover the stopper from the front side.

An outer end of the stopper 4 (more specifically an outer end of a stopper body 41) may be disposed more outwardly than an outer end of the cover 5 (more specifically an outer end of the cover part 51), and thus is exposed to the front, which will be described later with reference to FIG. 8.

Referring to FIG. 7, the cover 5 may be coupled to the cap decoration 3. While the cover 5 is coupled to the cap decoration 3, the upper end 54, the extension part 541 and 542, the coupling groove 53, and the rib 531 of the cover 5 may be exposed to the outside, such that the lower end bent portion 245 of the door panel 24 may be inserted into the coupling groove 53.

The cover 5 may pass through the cap decoration 3. The cover 5 may pass through the bottom 31 of the cap decoration 3. The cover part 51 may pass through the cap decoration 3 to protrude downward from the bottom 31 of the cap decoration 3. The cover part 51 may cover the stopper 4 in front of the stopper 4.

The door 2 may include an automatic closing device 68. The automatic closing device 68 may rotate the door 2 so that the door 2 may automatically close the storage compartment 11 even when no external force is applied while the door 2 is open.

The automatic closing device 68 may be disposed at the bottom of the door. The automatic closing device 68 may be mounted to a closing device mount 368 which will be described later.

The hinge may be provided at the top and bottom of each of a plurality of doors. In the following description, a hinge 61 disposed at the bottom of a first door 21 (see FIG. 1) will be described as an example.

Referring to FIGS. 7 to 9, the door 2 may include a bushing 62 into which the hinge shaft 611 is inserted. The bushing 62 may include a hinge recess 621 recessed upward from the lower surface 31 of the door to accommodate the hinge shaft 611.

The door 2 may be rotatably provided at the front of the cabinet 10 (see FIG. 1). A position of the rotation axis may vary according to an opening degree of the door.

Two or more hinge shafts are provided for one hinge 61, and the hinge recess 621 of the bushing 61 may extend in a curve. For example, as illustrated herein, the hinge 61 disposed at the bottom of the first door 21 may be provided with a center of rotation by two hinge shafts 611. In this case, the position of the rotation axis of the door may vary according to an opening degree of the door. That is, when the door 2 opens, the hinge shaft 611 may slide along the hinge recess 621 within the hinge recess 621.

The hinge recess 621 may include a first curved part 621a at which the hinge shaft is located (see 611c in FIG. 8) when the door is closed. The first curved part 621 may extend convexly rearward.

The hinge recess 621 may include a second curved part 621b (see FIG. 9B) at which the hinge shaft 611 is located when the door 2 opens to the maximum opening angle θ (the state in FIG. 8). The second curved part 621b may extend from the first curved part 621a. The second curved part 621b may have a smaller radius of curvature than the first curved part 621a.

In the case where the position c (see FIG. 9A) of the rotation axis of the door is fixed, an outer edge 29 of the door may deviate from a position of an outer end 28 of the door 2 in a closed state (see 29p of FIG. 9A), when the door opens.

In the structure of the hinge shaft 611 and the hinge recess 621 of the door 2 described above, the outer edge 29 of the door does not deviate from the position 28c of the outer end 28 of the door 2 in a closed state even when the door opens, or the extent to which the outer edge 29 of the door deviates may be minimized.

Accordingly, when other furniture is placed next to the refrigerator, or a refrigerator is placed in a refrigerator cabinet and the door of the refrigerator does not protrude more forwardly than other furniture or the refrigerator cabinet, the door may not interfere with other furniture or the refrigerator cabinet even when the door opens.

However, it is not necessary that the hinge shaft 611 and the hinge recess 621 have the above structure. For example, unlike the above example, the position of the rotation axis of the door may be fixed. One hinge shaft 611 may be provided for one hinge, and the hinge recess 621 of the bushing 62 may be recessed in a cylindrical shape, such that the one hinge shaft 611 may rotate in the bushing without sliding.

The hinge 61 may include a hinge bracket 63 fixed to the cabinet 63.

The hinge 61 may include a hinge extension part 613 extending forward. The hinge extension part 613 may extend forward from the hinge bracket 63. The hinge extension part 613 may be coupled to the hinge bracket 63. Alternatively, the hinge extension part 613 may be formed as one body with the hinge bracket 63.

The hinge extension part 613 may include a contact portion 614. The contact portion 614 may be located on a moving trajectory of the stopper 4 when the door 2 rotates. The contact portion 614 may be disposed on an outer portion of the hinge 61 in a width direction of the door 2.

The stopper 4 may come into contact with the contact portion 614 when the door 2 opens to the maximum opening angle θ.

Accordingly, the stopper 4 may limit rotation of the door.

In the width direction of the door 2, the outer end of the stopper body 41 may be disposed more outwardly than the outer end of the cover part 51.

The contact portion 614 may be inclined. The contact portion 614 may be inclined so that an inner end thereof is disposed at a front side and an outer end thereof is disposed at a rear side.

Accordingly, even when the door 2 opens to the maximum opening angle θ, the cover 5 may be spaced apart from the contact portion 614, thereby preventing damage.

Referring to FIGS. 9A and 9B, as described above, the door 2 of the refrigerator according to an embodiment of the present disclosure may have a smaller thickness than the door of the existing refrigerator. For example, a distance d1 between the cover and the front surface of the door in the thickness direction of the door (in the front-rear direction of the door in a closed state) may be shorter than a distance d2 between the hinge shaft and the cover.

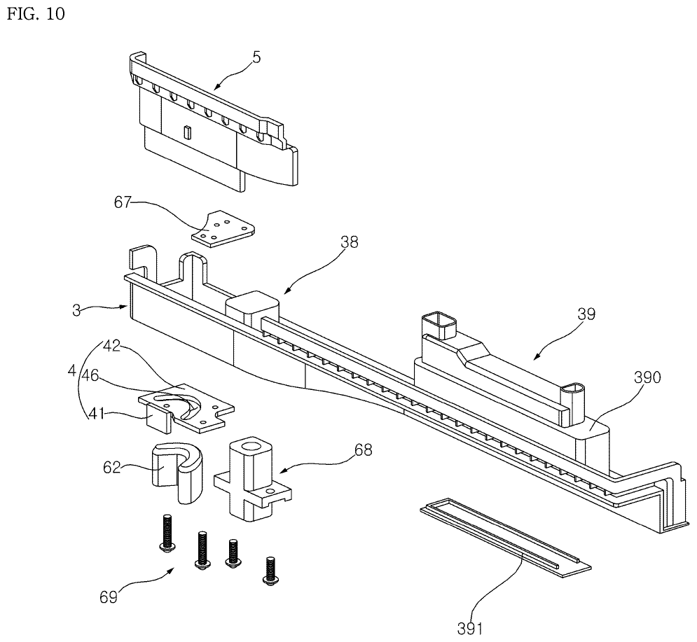

Referring to FIG. 10, the stopper 4 may include the stopper body 41 protruding downward from the door 2, and a base 42 fixed to a lower surface of the door 2. The stopper body 41 may protrude downward from the base 42.

A bushing insertion hole 46 may be formed in the base 42. The bushing 62 may pass through the base 42 to be coupled to the cap decoration 3.

The cap decoration 3 may include a hinge part 38 and a handle part 39. The hinge part 38 and the handle part 39 may be disposed in the width direction of the door. In the width direction of the door, the hinge part 38 may be located at an outer portion and the handle part 3 may be located at a center portion of the refrigerator 1. In the following description, the hinge part 38 may also be referred to as a first part 38, and the handle part 39 may also be referred to as a second part 39.

The hinge 61 may be disposed at the hinge part 38. In addition, the stopper 4, the cover 5, the bushing 62, the bracket 67, and the automatic closing device 68 may be disposed at the hinge part 38.

The cover 5 and the bracket 67 may be inserted from top to bottom of the cap decoration 3. The stopper 4, the bushing 62, and the automatic closing device 68 may be disposed at the lower side of the cap decoration 3.

The stopper 4, the cover 5, and the automatic closing device 68 may be fastened to the cap decoration 3 by a fastening member 69.

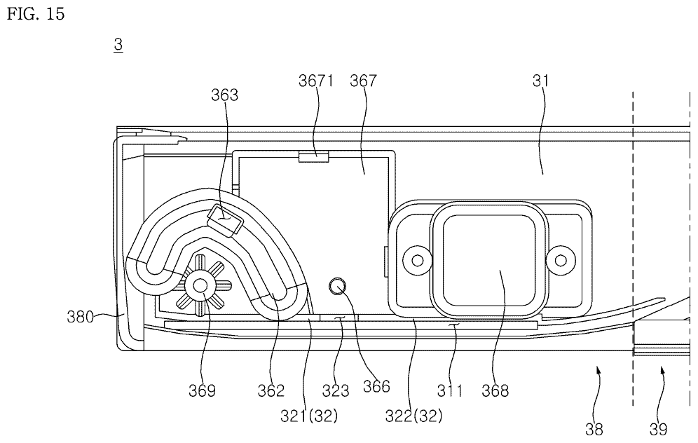

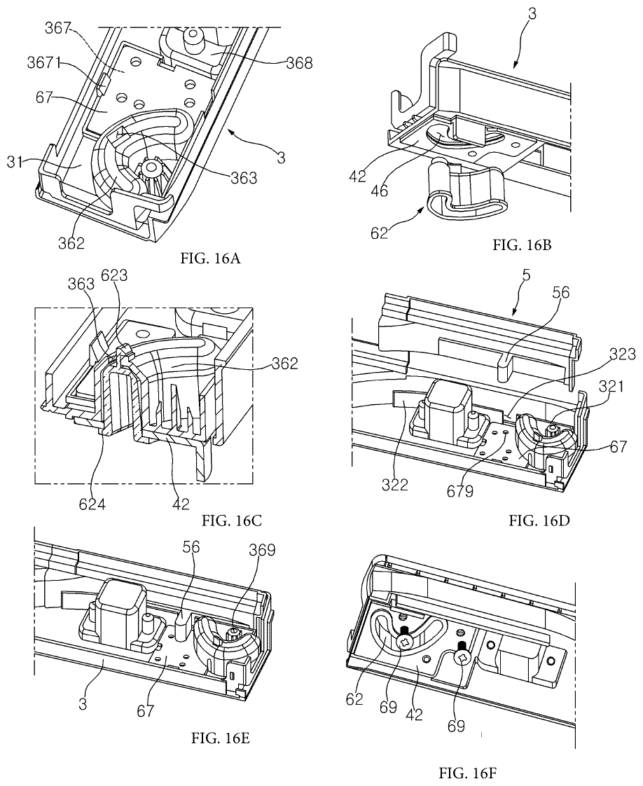

The assembly of the stopper 4, the cover 5, the hinge 61, the bushing 62, and the bracket 67 will be described in detail below with reference to FIGS. 15 and 16.

The handle part 39 may be provided with a handle 390. The handle 390 may have a recess which is recessed upward from the bottom of the cap decoration so that a user's hand may enter. The handle cover 391 may be disposed in the recess of the handle.

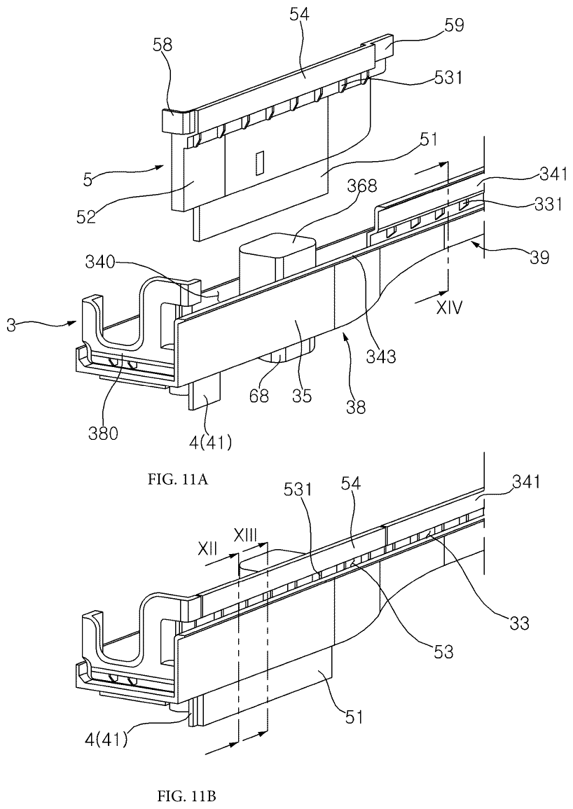

Referring to FIG. 11, the cap decoration 3 may include a side end 380, a hinge part 38, and a handle part 39.

The door panel 24 may define the front surface and the lateral surface of the door 2. That is, the door panel 24 may include a front surface and a lateral surface. The lateral surface of the door panel 24 may be coupled to the side end 380 of the cap decoration 3.

As for the hinge part 38, the front surface 35 may define the upper end of the hinge part 38. As for the handle part 39, an upper end 34 of the cap decoration, which has a shape corresponding to the upper end 54 of the cover 4, may be disposed at an upper side of the front surface 35.

That is, the upper side of the hinge part 38 may have a cut-off portion 340. The cut-off portion 340 may be formed by cutting off the cap decoration 3 after injection molding. Alternatively, the cut-off portion 340 may be an open portion that is open from the time of injection molding of the cap decoration 3.

The upper end 54 of the cover 5 may be disposed in the cut-off 340. A cover extension parts 541 and 542 may be disposed in the cut-off 340.

The cover 5 may include the cover body 52 and a first side end portion 58 bent rearward from the side end of the upper end 54. The first side end portion 58 may face the side end 380 of the cap decoration 3.

The cover 5 may further include a second side end portion 59 disposed behind the front surface and the upper end 34 of the handle part 39 of the cap decoration 3. The second side end portion 59 may extend along the front surface and the upper end 34 of the handle part 39. An upper portion of the second side end portion 59 is stepped rearward from the upper end 54 of the cover and may be disposed behind the upper end 34 of the cap decoration.

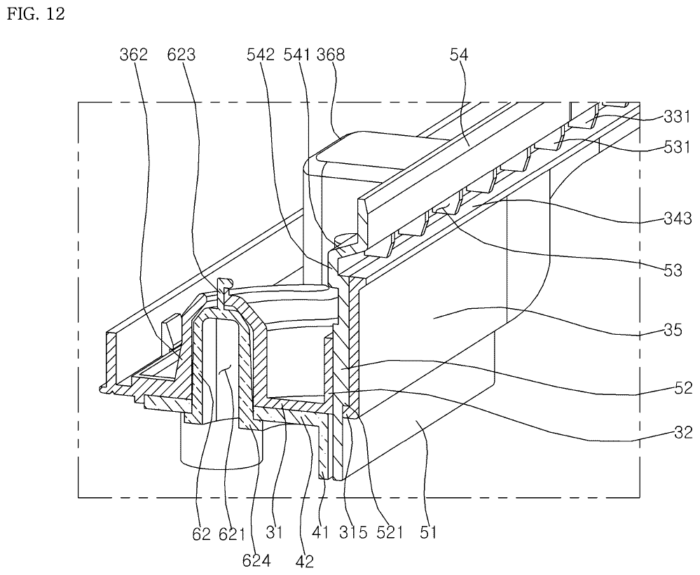

Referring to FIGS. 11A and 11B and 12, the cover 5 may vertically pass through the cap decoration 3. The cap decoration 3 may include a support wall 32 extending upward from the bottom 31 at the rear of the slit 311 (see FIG. 15). The cover 5 may be inserted between the support wall 32 and the front surface 35 to pass through the slit 311.

The slit 311 may be spaced rearward from the front surface 35. The front end 315 of the bottom 31 connected to the front surface 35 may be disposed in front of the slit 315.

The cover 5 may have a step 521 formed due to a difference in thickness between the cover body 52 and the cover part 51. The front surface of the cover part 51 may be disposed behind the front surface of the cover body 52, and the step 521 may connect a front bottom of the cover body 52 and a front top of the cover part 51.

The step 521 of the cover 5 may be formed at the front end 315 of the bottom 31 of the cap decoration 3.

The cap decoration 3 may include a bushing mount 362 in which the bushing 62 is mounted. The bushing mount 362 has a space recessed upward from the bottom 31 of the cap decoration 3, and the bushing 62 may be mounted in the space.

The bushing mount 362 may include a hook insertion hole 363 to which a hook 623 of the bushing 62 is coupled.

The bushing 62 may include a hinge recess 621 into which the hinge shaft 611 is inserted. The hinge recess 621 may be opened downward.

The bushing 62 may further include the hook 623 inserted into the hook insertion hole 363 and caught by the bushing mount 362.

The bushing 62 may have a rim 624 extending outward from the lower end. The rim 624 may extend along a circumference of the bushing 62.

The bushing 62 may pass through the bushing insertion hole 46 formed in the base 42 of the stopper, inserted into the bushing mount 362, and may be coupled to the cap decoration by the hook 623. The rim 624 may support the stopper 4. Accordingly, the stopper may be coupled to the lower surface of the door without a separate fastening member. In addition, the stopper 4 may be coupled to the cap decoration 3 before the fastening member 69 is fastened.

The cap decoration 3 may include the closing device mount 368 having a groove that is recessed upward from the bottom 31, and the automatic closing device 368 may be inserted into the closing device mount 368.

The cover part 51 may cover the stopper body 41 and the automatic closing device 368 at the front.

Referring to FIGS. 11A and 11B to 14, the cover 5 may include the upper end 54 disposed at the rear of the door panel 24. The cover 5 may include the first extension part 541 extending rearward from the upper end 54, and the second extension part 542 extending downward from the first extension part 541. The cap decoration 3 may include a protrusion 343 protruding forward from the upper end of the front surface 35.

A first coupling groove 53 may be formed between the upper end 54 of the cover, the first and second extension parts 541 and 542, and the protrusion 343. A rib 531 may be formed on the first coupling groove 53. A plurality of ribs 531 may be provided and arranged in the width direction of the door 2.

The rib 531 may be spaced upward from the protrusion 343. The rib 531 may be spaced upward from the cover body 52. The lower end bent portion 245 of the door panel 24 may be inserted between the rib 531 and the protrusion 343.

The handle part 39 may include the upper end 34 of the cap decoration that is disposed parallel to the upper end 54 of the cover, a first decoration extension part 341 that is disposed parallel to the extension parts 541 and 542 of the cover, and a second decoration extension part 341.

The protrusion 343 of the cap decoration may extend over the hinge part 38 and the handle part 39 in the width direction of the door 2.

A second coupling groove 33, extending from the first coupling groove, may be formed between the upper end 34 of the cap decoration, the first and second decoration extension parts 341 and 342, and the protrusion 343, and a rib 331 having a shape corresponding to the rib 531 of the cover 5 may be formed on the second coupling groove 33.

The lower end bent portion 245 of the door panel 24 may be inserted between the ribs 331 and 531 and the protrusion 343 to be coupled to the cap decoration 3 and the cover 5.

The front surface 35 of the cap decoration may extend over the hinge part 38 and the handle part 39 in the width direction of the door 2, in which the front surface may extend rearward from the side of the handle part 39. Accordingly, the front surface 35 on the side of the handle part 39 may be disposed behind the second decoration extension part 342, and a third decoration extension part may extend in the front-rear direction to connect the front surface 35 and the second decoration extension part 342.

In this structure, the undercut may not be formed in the side of the handle part 39.

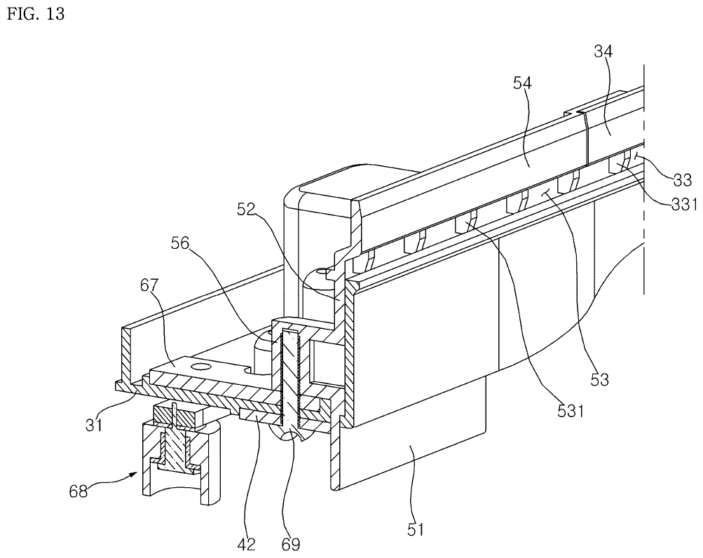

Referring to FIGS. 13 and 15, the cover 5 may include a fastening portion 56 protruding rearward from the cover body 52. The support wall 32 may include a first support wall 321 and a second support wall 322 which are spaced apart from each other in the width direction of the door, and an insertion hole 323 may be formed in a space therebetween. The fastening portion 56 may be inserted into the insertion hole 323.

The fastening portion 56 may be disposed between the bushing mount 362 and the closing device mount 368.

The cap decoration 3 may include a bracket mount 367 in which the bracket 367 is mounted. The bracket mount 367 may be disposed at the bottom of the cap decoration 3. The bracket mount 367 may be disposed between the bushing mount 362 and the closing device mount 368.

A fastening hole 366 may be formed in the bracket mount 367. The bracket 67 may have a fastening hole 679 (see FIGS. 16A to 16F) corresponding to the fastening hole 366 of the mount.

The fastening member 69 passes through the fastening holes 366 and 679 from below the bottom of the cap decoration 3, and is inserted into the fastening member 56, to fix the cover 5.

Further, a fastening hole corresponding to the fastening hole 366 and 679 is formed in the base 42 of the stopper, such that the stopper 4, the cap decoration 3, the bracket 67, and the cover 56 may be fastened by one fastening member 69.

Hereinafter, the assembly of other components to the cap decoration 3 will be described with reference to FIGS. 15 and 16A to 16F.

Referring to FIGS. 15 and 16A, the bracket 67 is inserted into the bracket mount 367 from top to bottom. A hook 3671 is provided at the edge of the bracket mount 367 such that the bracket 67 may be coupled to the bracket mount 367.

Referring to FIGS. 15, 16B, and 16C, the stopper 4 is disposed at a lower side of the cap decoration 3 so that the bushing insertion hole 46 may correspond to the bushing mount 362, and the bushing 62 is inserted into the bushing insertion hole 46 and the bushing mount 362.

The bushing 62 is pressed upward so that the hook 623 passes through the hook insertion hole to be caught by the bushing mount. When the bushing 62 is coupled to the bushing mount 362, the base 42 of the stopper may be supported by the rim 624.

Referring to FIGS. 15 and 16D, the cover 5 is inserted between the support wall 322 and the front surface 35 of the cap decoration 3 so that the fastening member 56 is inserted into the insertion hole 323, and the cover part 51 is inserted into the slit 311.

Referring to FIGS. 15, 16E, and 16F, the base 4 of the stopper, the cap decoration3, the bracket 67, and the fastening member 56 of the cover 5 are fastened by a first fastening member 69.

The base 42 of the stopper and the fastening portion 369 of the cap decoration are fastened by a second fastening member 69.

Accordingly, a plurality of components may be fastened using a small number of fastening members 69.

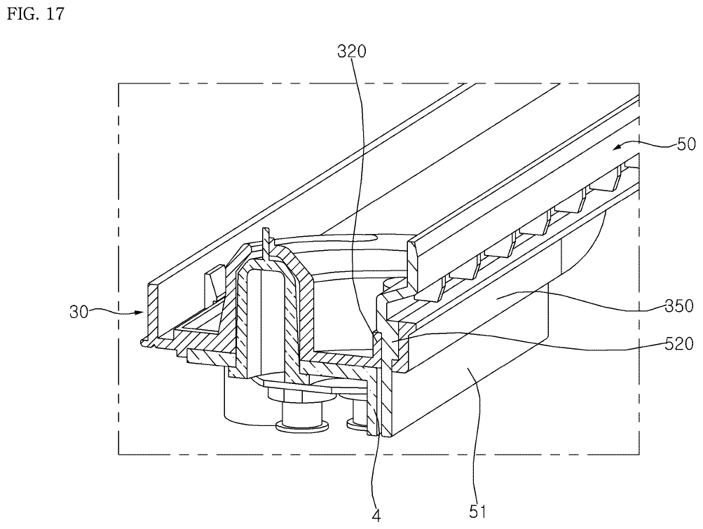

Hereinafter, a door of a refrigerator according to another embodiment of the present disclosure will be described with reference to FIG. 17. This embodiment is different from the above embodiments in that a front surface 350 of a cap decoration 50 and a cover body 520 decrease in height.

Referring to FIG. 17, the cover 50 may vertically pass through the cap decoration at a position behind the front end of the cap decoration 30. The cover part 51 may be disposed behind the front end 350 of the cap decoration 30. The cover part 51 may protrude downward from the lower surface of the door and may be disposed in front of the stopper 4, so as to at least partially cover the stopper from the front side.

A rear edge of the slit of the cap decoration 30, into which the cover part 51 is inserted, may protrude upward, so as to guide the cover part 51 to be easily inserted into the slit.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A refrigerator comprising:
a cabinet defining a storage compartment that is opened forward;
a door rotatably disposed at a front of the cabinet and configured to open and close the storage compartment; and
a hinge including a hinge extension part that is fixed to the cabinet and extends forward, and a shaft that extends upward from the hinge extension part and is inserted into a lower portion of the door,
wherein the door comprises:
a door panel defining a front surface of the door;
a cap decoration defining a lower surface of the door;
a stopper fixed to the lower surface of the door, protruding downward in front of the shaft of the hinge, and contacting the hinge extension part to limit rotation of the door; and
a cover protruding downward from the lower surface of the door behind a front surface of the lower portion of the door, the cover disposed in front of the stopper to at least partially cover the stopper from a front side.

2. The refrigerator of claim 1, wherein the cover vertically passes through the cap decoration at a position behind the front surface of the lower portion of the door to protrude downward from the lower surface of the door.

3. The refrigerator of claim 2, wherein the cap decoration comprises:
a bottom defining the lower surface of the door; and
a front surface facing forward and extending upward from the bottom to be connected to the door panel.

4. The refrigerator of claim 3, wherein a rear surface of the front surface of the cap decoration extends vertically from an upper end or extends obliquely and downwardly from the upper end.

5. The refrigerator of claim 3, wherein the door panel comprises a lower end bent portion that is bent rearward from the front surface of the door,
wherein the cover comprises:
an upper end disposed at a rear of the door panel; and
a cover extension part extending rearward and downward from the upper end,
wherein a first coupling groove is formed between the front surface of the cap decoration and the upper end of the cover,
wherein the lower end bent portion of the door panel is accommodated in the first coupling groove.

6. The refrigerator of claim 5, wherein the cover further comprises a rib protruding from the cover extension part toward the door panel, the rib spaced upward from the front surface of the cap decoration,
wherein the lower end bent portion of the door panel is inserted between the rib and the front surface of the cap decoration.

7. The refrigerator of claim 5, wherein the cap decoration comprises a first part and a second part that are arranged in a width direction of the door,
wherein the hinge, the stopper, and the cover are disposed at the first part, the front surface of the cap decoration defines an upper end of the first part, and the upper end of the cover and the cover extension part are disposed at an upper side of the upper end of the first part,
wherein the second part comprises:
a first decoration extension part that is disposed parallel to the upper end of the cover;
a second decoration extension part that is disposed parallel to the cover extension part and defines a second coupling groove extending from the first coupling groove; and
a third decoration extension part extending rearward from a lower end of the second decoration extension part,
wherein a front surface of the second part is connected to a rear end of the third decoration extension part and is disposed behind a front surface of the first part.

8. The refrigerator of claim 5, wherein the cap decoration comprises a slit extending from the bottom along the front surface in a width direction of the door, the slit disposed at a rear of the front surface,
wherein the cover comprises:
a cover body extending downward from a lower end of the cover extension part, and disposed at the rear of the front surface of the cap decoration; and
a cover part extending downward from the cover body, passing through the slit, and protruding downward from the lower surface of the door to at least partially cover the stopper from the front side.

9. The refrigerator of claim 8, wherein the slit is spaced rearward from the front surface of the cap decoration, and the front surface of the cover part is disposed behind the front surface of the cover body such that a step is formed between the front surface of the cover body and the front surface of the cover part,
wherein the step is supported by the bottom of the cap decoration.

10. The refrigerator of claim 8, wherein the cap decoration comprises a support wall protruding upward from a rear side of the slit,
wherein the cover body is inserted between the front surface of the cap decoration and the support wall.

11. The refrigerator of claim 10, wherein the support wall comprises a first support wall and a second support wall that are spaced apart from each other in a width direction of the door,
wherein the cover further comprises a fastening portion protruding rearward from the cover body and inserted between the first support wall and the second support wall,
wherein the refrigerator further comprises a first fastening member passing through the cap decoration from below the cap decoration, and coupled to the fastening portion.

12. The refrigerator of claim 11, wherein the stopper comprises:
a stopper base coupled to a lower side of the bottom of the cap decoration; and
a stopper body extending downward from the stopper base, and coming into contact with the hinge extension part based on the door being opened to a maximum opening angle,
wherein the first fastening member passes through the stopper base and the bottom of the cap decoration to be fastened to the fastening portion.

13. The refrigerator of claim 1, further comprising a bushing configured to accommodate the shaft of the hinge and including a hook that protrudes upward,
wherein the cap decoration further comprises a bushing mount recessed upward from a bottom of the cap decoration to accommodate the bushing, and having a hole into which the hook is inserted,
wherein the stopper comprises a stopper base coupled to a lower side of the bottom of the cap decoration, and having a bushing insertion hole into which the bushing is inserted,
wherein the bushing has a rim extending outward from a lower end and supporting the stopper base.

14. The refrigerator of claim 1, wherein the stopper comprises:
a stopper base coupled to a lower side of a bottom of the cap decoration; and
a stopper body extending downward from the stopper base,
wherein the cover comprises a cover part protruding downward from the lower surface of the door, and one end of the stopper body is disposed more outwardly than one end of the cover in a width direction of the door to be exposed forward.

15. The refrigerator of claim 14, wherein the hinge extension part comprises a contact portion that comes into contact with the stopper body when the door opens to a maximum opening angle,
wherein the contact portion is inclined so that an inner end thereof is disposed at a front side and an outer end thereof is disposed at a rear side.

16. The refrigerator of claim 1, wherein a distance between the cover and the front surface of the door in a thickness direction of the door is shorter than a distance between the shaft of the hinge and the cover.

17. The refrigerator of claim 1, further comprising a bushing recessed upward from a bottom of the cap decoration to accommodate the shaft of the hinge,
wherein a groove of the bushing comprises:
a first curved part at which the shaft of the hinge is located when the door is in a closed state, the first curved part extending convexly rearward; and
a second curved part at which the shaft of the hinge is located when the door opens to a maximum opening angle, the second curved part extending from the first curved part and having a smaller radius of curvature than the first curved part.

18. A refrigerator comprising:
a cabinet defining a storage compartment that is opened forward;
a door rotatably disposed at a front of the cabinet and configured to open and close the storage compartment; and
a hinge including a hinge extension part that is fixed to the cabinet and extends forward, and a shaft that extends upward from the hinge extension part and is inserted into a lower portion of the door,
wherein the door comprises:
a stopper fixed to a lower surface of the door, protruding downward in front of the shaft of the hinge, and contacting the hinge extension part when the door opens to a predetermined maximum opening angle, to limit rotation of the door; and
a cover provided on the lower surface of the door, protruding downward behind a front surface of the door, and disposed in front of the stopper to at least partially cover the stopper from a front side,
wherein a distance between the cover and the front surface of the door in a front-rear direction when the door closes the storage compartment is shorter than a distance between the shaft of the hinge and the cover in the front-rear direction.

19. The refrigerator of claim 18, wherein the cover vertically passes through a cap decoration at a position behind the front surface of the lower portion of the door, so as to protrude downward.

20. A refrigerator comprising:
a cabinet defining a storage compartment that is opened forward;
a door rotatably disposed at a front of the cabinet and configured to open and close the storage compartment; and
a hinge including a hinge extension part that is fixed to the cabinet and extends forward, and a shaft that extends upward from the hinge extension part and is inserted into a lower portion of the door,
wherein the door comprises:
a door panel defining a front surface of the door;
a cap decoration defining a lower surface of the door;
a stopper fixed to the lower surface of the door, protruding downward in front of the shaft of the hinge, and contacting the hinge extension part when the door opens to a predetermined maximum opening angle, to limit rotation of the door; and
a cover vertically passing through the cap decoration at a position behind the front surface of the lower portion of the door and protruding downward from the lower surface of the door, the cover disposed in front of the stopper to at least partially cover the stopper from a front side.
